(19) United States
(12) Patent Application Publication
(10) Pub. No.: US 2025/0322472 A1
(43) Pub. Date: Oct. 16, 2025

(54) NEGOTIATION DEVICE, NEGOTIATION METHOD, AND STORAGE MEDIUM

(71) Applicant: NEC Corporation, Tokyo (JP)

(72) Inventors: Tomohito ANDO, Tokyo (JP); Satoshi MORINAGA, Tokyo (JP); Yasser Farouk Othman MOHAMMAD, Tokyo (JP)

(73) Assignee: NEC Corporation, Tokyo (JP)

(21) Appl. No.: 19/095,084

(22) Filed: Mar. 31, 2025

(30) Foreign Application Priority Data
Apr. 16, 2024 (JP) 2024-066148

(51) Int. Cl. G06Q 50/18

(52) U.S. Cl. CPC G06Q 50/188

(57) ABSTRACT

The negotiation device 1X mainly includes an environmental load calculation means 35X and a proposal generation means 30X. The environmental load calculation means 35X is configured to calculate environmental loads regarding an order subject to a negotiation conducted by a first negotiator with a second negotiator. The proposal generation means 30X is configured to generate a proposal regarding the order based on the environmental loads.

### INCORPORATION BY REFERENCE

This application is based upon and claims the benefit of priority from Japanese Patent Application No. 2024-066148, filed on Apr. 16, 2024, the disclosure of which is incorporated herein in its entirety by reference.

### TECHNICAL FIELD

The present disclosure relates to a technical field of a negotiation device, a negotiation method, and a storage medium.

### BACKGROUND

A system is known in which automatic negotiations on the condition adjustment between an orderer and a contractor is performed. For example, Patent Literature 1 discloses an automatic negotiation system configured to previously store proposals for negotiations according to possible orders from the orderer and then preferentially select a proposal having the largest utility with respect to the terms and conditions of negotiations received from the orderer to transmit the selected proposal to the orderer.

### CITATION LIST

### Patent Literature

Patent Literature 1: WO2021/024414

### SUMMARY

In general, since environmental loads occur in the production process and transportation process of ordered products, there is a demand for negotiators who prioritize environmental issues to conduct negotiations regarding orders in consideration of the impact on the environment.

In view of the above-described issues, one object of the present disclosure is to provide a negotiation device, a negotiation method, and a program capable of conducting negotiations in consideration of the environment.

In an example aspect of the present disclosure, there is provided a negotiation device including:
an environmental load calculation means configured to calculate environmental loads regarding an order subject to a negotiation conducted by a first negotiator with a second negotiator;
and a proposal generation means configured to generate a proposal regarding the order based on the environmental loads.

In an example aspect of the present disclosure, there is provided a negotiation method executed by a computer, including:
calculate environmental loads regarding an order subject to a negotiation conducted by a first negotiator with a second negotiator; and
generate a proposal regarding the order based on the environmental loads.

In an example aspect of the present disclosure, there is provided a program executed by a computer, the program causing the computer to:
calculate environmental loads regarding an order subject to a negotiation conducted by a first negotiator with a second negotiator; and
generate a proposal regarding the order based on the environmental loads.

An example advantage according to the present disclosure is to conduct negotiations in consideration of the environment.

### BRIEF DESCRIPTION OF THE DRAWINGS

FIG. 1 illustrates a configuration of the negotiation system.

FIG. 2 illustrates the hardware configuration of the platform providing device.

FIG. 3 illustrates the hardware configuration of the terminal device.

FIG. 4 illustrates an example of functional blocks in the negotiation platform.

FIG. 5 illustrates an example of an offer editing screen image before input by a negotiator.

FIG. 6 illustrates an example of an offer editing screen image after the input by the negotiator.

FIG. 7 illustrates an example of a flowchart executed by the platform providing device.

FIG. 8 illustrates the configuration of the negotiation system.

FIG. 9 illustrates a functional block diagram of a negotiation device.

FIG. 10 illustrates an example of a flowchart showing a procedure of the process by the negotiation device.

### EXAMPLE EMBODIMENTS

Hereinafter, example embodiments of a negotiation device, a negotiation method, and a storage medium will be described with reference to the drawings.

In the following explanation, the term “negotiation” refers to an adjustment of terms and conditions until the conclusion of an agreement between a party that places an order and a party that receives an order. In this example embodiment, the term “negotiations” mainly indicates actions taken by the parties to alternatively offer and counteroffer a proposal (also referred to as “offer”) for the agreement on the terms and conditions of the order. The negotiations in this case may be negotiations between parties with conflicting interest or may be negotiations (so-called adjustment) between parties without conflicting interest. Also, examples of target terms and conditions (so-called issue) of negotiations include prices of products, due dates, quantities, environmental loads, means of transportation, resources (airspace if a drone is used as means of transportation), functions, and qualities. The term “negotiator” also refers to a subject that is responsible for placing an order and receiving an order, and has, for example, the ability to provide a proposal for agreement to the other negotiator, and the ability to determine whether or not to agree on the offer supplied from the other negotiator. The negotiator may be an individual or may be an organization. The negotiator may negotiate using an AI, a robotics, or any other device (including a drone and an autonomous vehicle) to reflect the intention of the individual or organization.

### First Example Embodiment

### (1) System Configuration

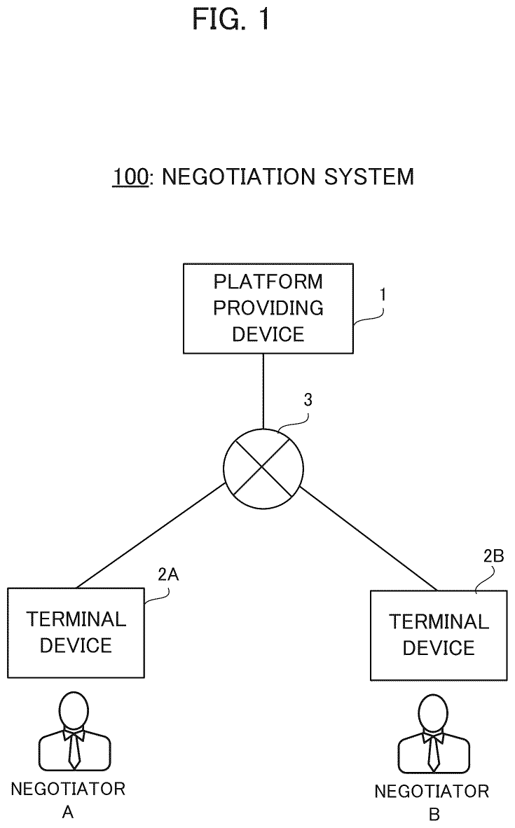

FIG. 1 illustrates the configuration of a negotiation system 100. The negotiation system 100 mainly includes a platform providing device 1 that provides an electronic negotiation platform for negotiating terms and conditions, and a terminal device 2A and a terminal device 2B that are used by negotiators that conduct negotiations on the negotiation platform provided by the platform providing device 1. The platform providing device 1, the terminal device 2A, and the terminal device 2B perform data communication via the network 3 with one another. In FIG. 1, as an example, a terminal device 2A used by the negotiator A, and a terminal device 2B used by the negotiator B is illustrated, and hereafter, when the terminal device 2A and the terminal device 2B are not particularly distinguished, these are simply referred to as “terminal device 2”.

Hereinafter, the negotiations between the negotiator A and the negotiator B on a one-to-one basis will be described as an example. It is noted that negotiations with competitive quotes, total amount negotiations, nested negotiations may be performed by combining a plurality of one-to-one basis negotiations to be described below.

The platform providing device 1 provides a negotiation platform required for negotiations of terms and conditions between the negotiator A and the negotiator B through the terminal device 2A and the terminal device 2B. For example, the negotiator who places an order is a manufacturer of products, and the negotiator who receives the order is a supplier who supplies components (parts) necessary for the manufacture of the products. The platform providing device 1 generates display information required for display of information required for negotiations, and transmits the generated display information to the terminal device 2A and the terminal device 2B to control the display of the terminal device 2A and the terminal device 2B. In this instance, the platform providing device 1 receives the input information related to the offer from the terminal device 2A and the terminal device 2B and generates the above-described display information based on the received input information. The platform providing device 1 is an example of the “negotiation device”.

The terminal device 2 (2A, 2B) are communication devices used by the negotiators, and, on the basis of the data communication with the platform providing device, displays the information or accepts the input from the negotiators. In the present example embodiment, as an example, the negotiator A shall conduct automated negotiations through a negotiation AI (the description of the negotiation AI will be given later) in principle, and the negotiator B shall conduct negotiations (hereinafter, also referred to as “manual-based negotiations”) based on a manual input through the terminal device 2B without using any negotiation AI. It is noted that upon determining that the automated negotiation by the negotiation AI does not lead to an agreement, or upon determining, in other cases, that manual-based negotiations are required, the negotiator A can switch to the manual-based negotiations based on the input through the terminal device 2A.

The configuration of the negotiation system 100 shown in FIG. 1 is an example, and various changes may be made to the configuration. For example, the platform providing device 1 may be configured by a plurality of devices. In this case, the plurality of devices constituting the platform providing device 1 performs transmission and reception of information necessary for executing the pre-allocated process among the plurality of devices.

### (2) Hardware Configuration

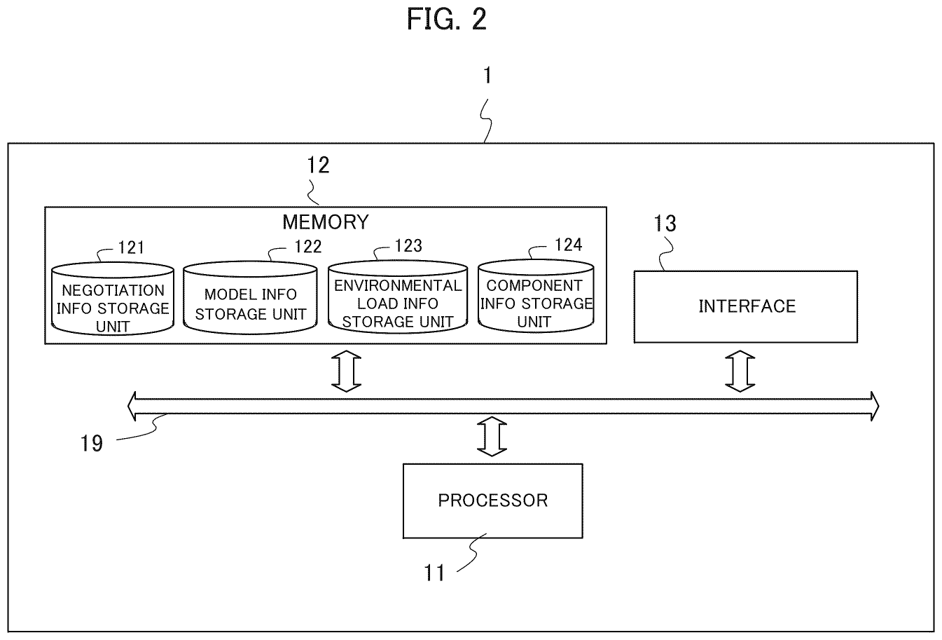

FIG. 2 shows the hardware configuration of the platform providing device 1. The platform providing device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories and non-volatile memories such as a RAM (Random Access Memory) and a ROM (Read Only Memory). The memory 12 further stores a program for executing various process by the platform providing device 1. The memory 12 is also used as a working memory.

The memory 12 functionally includes a negotiation information storage unit 121, a model information storage unit 122, an environmental load information storage unit 123, and a component information storage unit 124.

The negotiation information storage unit 121 stores negotiation information which is information relating to the negotiations between the negotiator A and the negotiator B. The negotiation information storage unit 121 includes information on an offer currently-agreed between negotiator A and negotiator B. For example, order numbers are assigned to products subject to orders according to the types of the products, and the offer indicates a proposal (draft) of terms and conditions relating to plural order numbers.

The model information storage unit 122 stores model information (including parameters) for configuring a negotiation AI which is an artificial intelligence model for negotiating with the other negotiator as an agent for the negotiator. The negotiation AI is utilized for negotiating with the other negotiator (here, negotiator B) by the negotiator A which is an individual or an organization.

The negotiation AI include an acceptance strategic function that makes a determination (so-called acceptance determination) as to whether or not to agree on an offer provided by the other negotiator, and an offer generation function that generates an offer. Examples of the offer generation include the generation of an alternative offer (also referred to as “counteroffer”) upon determining that the offer provided by the other negotiator cannot be agreed upon. Any technique may be used to generate an offer, such as beam search, grid search, search by probabilistic optimization such as a genetic algorithm, search by Bayesian optimization, and a combination thereof.

In some embodiments, the negotiation AI may calculate the utility using the utility function for calculating the degree of goodness of the offer, and then, based on the utility, makes the acceptance determination as to the offer supplied from the other negotiator and determines an offer to provide with the other negotiator. For example, the negotiation AI may decide to accept an offer whose utility is greater than or equal to a predetermined threshold value, and may decide not to accept an offer whose utility is less than the above-mentioned threshold value. The negotiation AI may also make plural options for an offer, and determine the offer by selecting the option having the highest utility to notify the other negotiator. It is noted that a method of determining an offer based on a utility function is disclosed in, for example, Patent Literature 1. As will be described later, the negotiation AI may consider the environmental loads (impact) in the calculation of the utility using the utility function.

The environmental load information storage unit 123 stores environmental load information that is information relating to the environmental loads caused in the production process for each product. The environmental load information is, for example, a database in which index values of the environmental loads are associated with respective types of products. Examples of the products include any products or their components (including any resources such as raw materials) subject to order. Examples of the index of the environmental load include an index that represents the quantity of a particular chemical (e.g., CO2 or NOx), an index that quantitatively represents the amount of the consumption of a resource (e.g., iron and/or copper), an index that represents the impact on a particular event such as air pollution or global warming, and a total index of the environmental loads that takes these indices into account comprehensively. An IDEA database is included in examples of the database in which index values of the environmental loads are associated with respective types of products.

The component information storage unit 124 stores component information indicating relations between products and components (resources) serving as parts of the products. The component information is, for example, a database or a table, with respect to each product, having records associated with components of the each product, and examples of the component information include a BOM (Bill Of Materials).

The interface 13 is one or more interfaces for electrically connecting the platform providing device 1 to other devices. Examples of the interfaces include a wireless interface, such as network adapters, for transmitting and receiving data to and from other devices wirelessly, and a hardware interface, such as a cable, for connecting to other devices.

The hardware configuration of the platform providing device 1 is not limited to the configuration shown in FIG. 2. For example, the platform providing device 1 may include at least one of an input device, a display device, and/or a sound output device. At least a portion of the information stored in the memory 12 may be stored in one or more storage devices other than the platform providing device 1. In this case, examples of the storage devices include a hard disk connected to the platform providing device 1, a storage medium such as a flash memory, and a server device that performs data communication with the platform providing device 1.

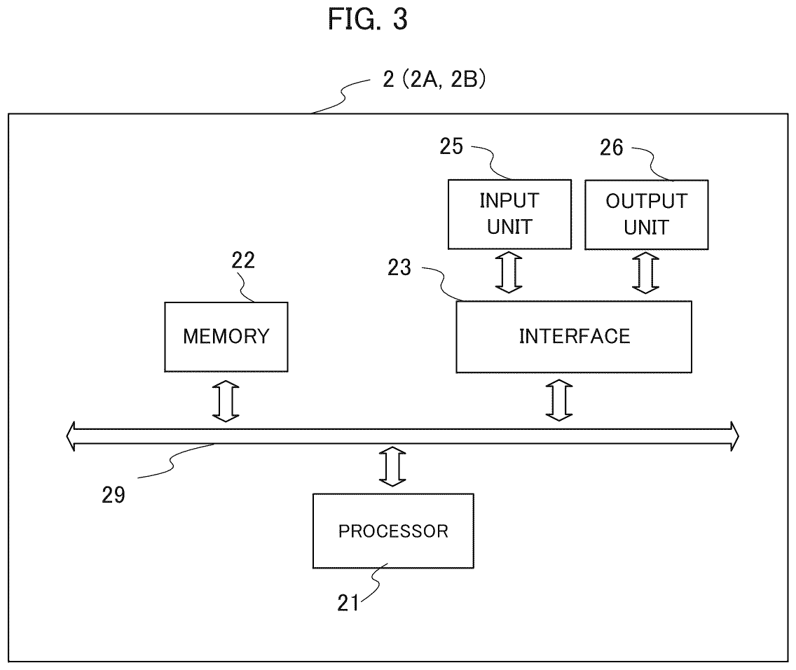

FIG. 3 shows the hardware configuration of the terminal device 2, that is, the hardware configuration common to the terminal device 2A and the terminal device 2B. The terminal device 2 includes a processor 21, a memory 22, and an interface 23 as hardware. The processor 21, memory 22, and interface 23 are connected to one another via a data bus 29.

The processor 21 executes a predetermined process by executing a program stored in the memory 22. Examples of the processor 21 is a processor such as a CPU, a GPU, and a TPU. The processor 21 may be configured by a plurality of processors. The processor 21 is an example of a computer.

The memory 22 is configured by various volatile memories and non-volatile memories such as a RAM (Random Access Memory) and a ROM (Read Only Memory). Further, in the memory 22, a program for executing various processes by the platform providing device 1 is stored. The memory 22 is also used as a working memory.

The interface 23 is one or more interfaces for electrically connecting the terminal device 2 to other devices. Examples of the interfaces include a wireless interface, such as a network adapter, for transmitting and receiving data to and from other devices wirelessly, and a hardware interface, such as a cable, for connecting to other devices.

The interface 23 performs the interface operation of the input unit 25 and the output unit 26. The input unit 25 is a user interface that receives an input that is an external input, and examples of the input unit 25 include a touch panel, a button, a keyboard, and a voice input device. The interface 23 supplies the input signal generated by the input unit 25 to other components in the terminal device 2 or a device existing outside the platform providing device 1. The output unit 26 performs display or audio output of predetermined information based on the output signal supplied through the interface 23. Examples of the output unit 26 include a display, a projector, and an audio output device.

The hardware configuration of the terminal device 2 is not limited to the configuration shown in FIG. 3. For example, at least one of the input unit 25 and/or the output unit 26 may be configured separately from the terminal device 2.

### (3) Overview of Negotiation Platform

Next, an outline of a negotiation platform implemented by the platform providing device 1 will be described. The platform providing device 1 generates an offer based on the environmental load in the automated negotiation by the negotiation AI used by the negotiator A and determines whether or not to accept the offer considering the environmental loads. Thereby, it is possible to carry out business negotiations considering environmental loads such as a negotiation to lower environmental loads in exchange for a delay in the delivery and a price raise.

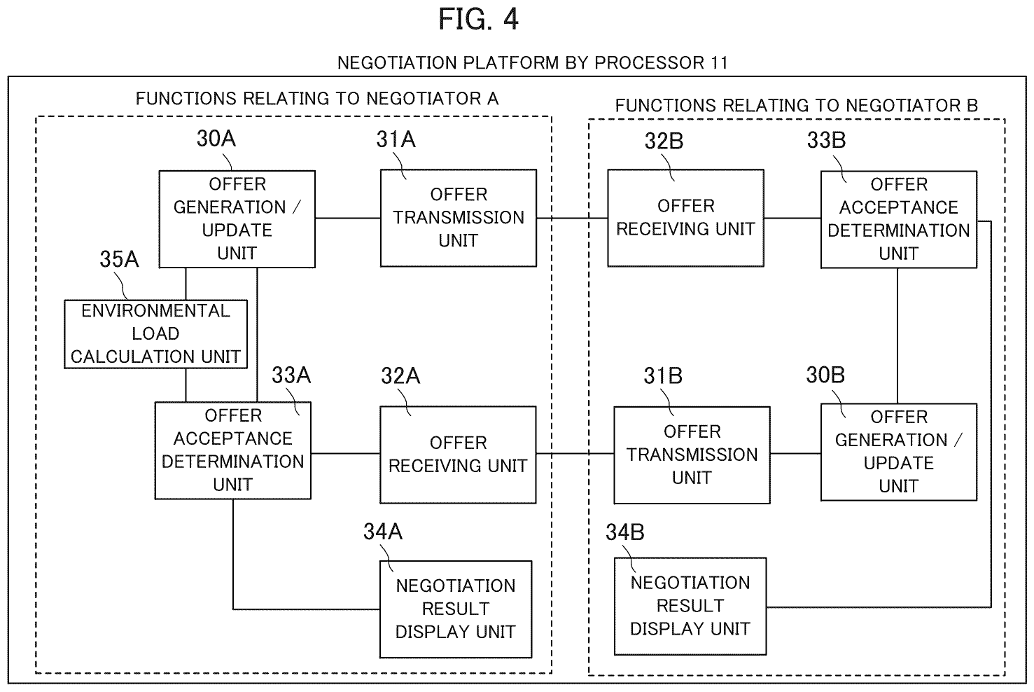

FIG. 4 is an example of a functional block in a negotiation platform implemented by the processor 11 of the platform providing device 1. The negotiation platform includes an offer generation/update unit 30A, an offer transmission unit 31A, an offer receiving unit 32A, an offer acceptance determination unit 33A, a negotiation result display unit 34A, and an environmental load calculation unit 35A as functions relating to the negotiator A. The negotiation platform includes an offer generation/update unit 30B, an offer transmission unit 31B, an offer receiving unit 32A, an offer acceptance determination unit 33B, and a negotiation result display unit 34B as functions relating to the negotiator B. In FIG. 4, blocks to exchange data with each other are connected by a solid line, but the combination of the blocks to exchange data with each other is not limited thereto. The same applies to the drawings of other functional blocks described below.

First, the functions relating to the negotiator A will be described.

The offer generation/update unit 30A generates and updates an offer by the negotiation AI. The term “updating an offer” refers to generating a counteroffer upon determining that an offer supplied from the negotiator B is unacceptable. In this case, for example, the processor 11 configures the negotiation AI referring to the model information stored in the model information storage unit 122 and executes the process related to the offer generation/update unit 30A.

In this instance, the offer generation/update unit 30A generates the offer based on the calculation result regarding the environmental loads by the environmental load calculation unit 35A and the negotiation information stored in the negotiation information storage unit 121. Upon receiving, from the offer acceptance determination unit 33A, the latest offer received by the the offer receiving unit 32A and the determination result indicating that the offer cannot be accepted, the offer generation/update unit 30A generates a counteroffer. Even in this situation, the offer generation/update unit 30A generates a counteroffer based on the calculation result of the environmental loads by the environmental load calculation unit 35A. The generation and update of the offer based on environmental loads will be described later. The offer generation/update unit 30A supplies the generated or updated offer to the offer transmission unit 31A.

The offer transmission unit 31A supplies information indicating the offer generated or updated by the offer generation/update unit 30A to the offer receiving unit 32B. For example, the processor 11 functions as an offer transmission unit 31A to generate display information for displaying the offer generated or updated by the offer generation/update unit 30A on the terminal device 2B. Then, the processor 11 transmits the generated display information to the terminal device 2B through the interface 13.

The offer receiving unit 32A receives information indicating an offer supplied from the offer transmission unit 31B, which will be described later. In this case, for example, the processor 11 functions as an offer receiving unit 32A and receives information indicating an offer supplied from the offer transmission unit 31B to be described later.

The offer acceptance determination 33A determines whether or not to accept (i.e., agree on) the offer which the offer receiving unit 32A has received. In this case, for example, the processor 11 configures the negotiation AI with reference to the model information stored in the model information storage unit 122 and executes the process related to the offer acceptance determination unit 33A.

In this instance, the offer acceptance determination unit 33A supplies the information indicating the above-described offer to the environmental load calculation unit 35A, and receives, from the environmental load calculation unit 35A, the calculation result regarding the environmental loads of the above-described offer calculated based on the supplied information by the environmental load calculation unit 35A. The offer acceptance determination unit 33A determines, based on the calculation result of the environmental loads of the offer calculated by the environmental load calculation unit 35A, whether or not to accept the offer.

The environmental load calculation unit 35A does not need to generate the calculation result regarding the above-described environmental loads if the information indicating the offer supplied from the negotiator B includes the information regarding the environmental loads. In such cases, the offer acceptance determination unit 33A determines whether or not to accept the offer using the data on the environmental loads supplied from the negotiator B. Alternatively, the environmental load calculation unit 35A may generate the calculation result regarding the above-described environmental loads even when information regarding the environmental loads is included in the information indicating the offer supplied from the negotiator B. In this instance, the offer acceptance determination unit 33A determines, based on the calculation result generated by the environmental load calculation unit 35A, whether or not to accept the offer. As described above, the environmental load calculation unit 35A may generate the calculation result regarding the above-described environmental loads, regardless of whether or not the information regarding the environmental loads is included in the information indicating the offer supplied from the negotiator B.

Upon determining that the whole of the offer received by the offer receiving unit 32A is acceptable, the offer acceptance determination unit 33A supplies information (i.e., information indicating the offers received by the offer receiving unit 32A) indicating the agreed offer to the negotiation result display unit 34A. The offer acceptance determination unit 33A may also provide the negotiation result display unit 34B with information indicating the agreed offer.

Upon determining that the offer received by the offer receiving unit 32A is not acceptable and it is necessary to switch to the manual-based negotiations, the offer acceptance determination unit 33A supplies information indicating the offer at the present time to the negotiation result display unit 34A. The offer acceptance determination unit 33A may supply the above-described information to the negotiation result display unit 34B in the same manner. For example, the offer acceptance determination unit 33A needs to switch to manual-based negotiations upon determining the offer which the offer receiving unit 32A received at the last time has no change (i.e., the negotiations are not advanced) from the offer which the offer receiving unit 32A received at the last but one time. In another instance, upon receiving a request for the suspension of negotiations from the negotiator B, the offer acceptance determination unit 33A determines that the negotiations should be switched to manual-based negotiations.

On the other hand, upon determining that the offer which the offer receiving unit 32A has received is not acceptable and there is no need to switch to manual-based negotiations, the offer acceptance determination unit 33A supplies the information indicating the received offer and the determination result indicating that the offer cannot be accepted to the offer generation/update unit 30A. The offer acceptance determination unit 33A determines that there is no need to switch to manual-based negotiations if there is a substantial variation between the last offer received by the offer receiving unit 32A and the last but one offer received by the offer receiving unit 32A. In another instance, the offer acceptance determination unit 33A determines that it is not necessary to switch to manual-based negotiations if there is no request for suspension of negotiations from the negotiator B.

The negotiation result display unit 34A displays on the terminal device 2A the negotiation result based on the information received from the offer acceptance determination unit 33A. In this instance, the processor 11 functions as the negotiation result display unit 34A to generate display information based on the information received from the offer acceptance determination unit 33A and supplies the generated display information to the terminal device 2A. For example, if the offer is agreed, the negotiation result display unit 34A displays on the terminal device 2A the information on the agreed offer based on the information received from the offer acceptance determination unit 33A. On the other hand, if the offer has not been agreed, the negotiation result display unit 34A displays on the terminal device 2A the information regarding the offer immediately before the suspend of the negotiations. The negotiation result display unit 34A may display the negotiation result based on the information received from the offer acceptance determination unit 33B or the like on the terminal device 2A if the offer acceptance determination unit 33B makes the determination of the suspend of the negotiations.

The environmental load calculation unit 35A calculates the environmental loads caused by the implementation of the transaction according to an offer (or an option for the offer) which is generated or updated by the offer generation/update unit 30A or which the offer acceptance determination unit 33A has decided to accept. In this case, for example, the processor 11 configures a negotiation AI by referring to the model information stored in the model information storage unit 122 and executes the process relating to the environmental load calculation unit 35A.

The environmental load calculation unit 35A calculates value(s) of one or more indices related to the environmental loads for an offer that is generated or updated by the offer generation/update unit 30A or for an offer subject to acceptance determination by the offer acceptance determination unit 33A. Examples of the index value of environmental loads include kilograms of carbon dioxide emissions per US dollar. In this instance, by referring to the environmental load information stored in the environmental load information storage unit 123 and the calculation information stored in the component information storage unit 124, the environmental load calculation unit 35A calculates an index value of the environmental loads required for producing respective target products of order, which are identified by the offer.

Specifically, the environmental load calculation unit 35A identifies components (resources) used for each product identified by the offer by referring to component information corresponding to the each product. For example, if the products are vehicles, examples of the components thereof include engines, wheels, batteries, and the like. Then, the environmental load calculation unit 35A identifies index values of the environmental loads of identified components by referring to the environmental load information corresponding to the identified components. Then, the environmental load calculation unit 35A calculates the sum of the index values of the environmental loads of the identified components related to the products included in the offer, and uses the calculated sum as the index value of the environmental loads corresponding to the offer. The environmental load calculation unit 35A may sum the index values of the environmental loads for each order number included in the offer to calculate the index value of the environmental loads for each order number.

In addition, when the transportation (i.e., transportation means) of the products are specified in the offer, the index value of the environmental loads according to the specified transportation are also calculated. In this instance, for example, the environmental load calculation unit 35A may calculate the index value of the environmental loads due to the product transportation by referring to information in which an index value of the environmental loads to be set is associated with every possible transportation means. In another example, the environmental load calculation unit 35A may refer to a predetermined equation or a look-up table that includes elements which affect environmental loads as parameters (factors), such as the total weight of the products, the transportation distance, and the transportation means. Then, the environmental load calculation unit 35A calculates the index value of the environmental loads caused by the product transportation. The above-described equation or look-up table is previously stored, for example, in memory 12. The environmental load calculation unit 35A supplies the calculated index value to the offer generation/update unit 30A or the offer acceptance determination unit 33A as a result of calculation of the environmental loads.

Next, the functions relating to the negotiator B will be described.

The offer receiving unit 32B receives information indicating the offer supplied from the offer transmission unit 31A. In this case, for example, the terminal device 2B functions as an offer receiving unit 32B under the control of the processor 11, and receives information indicating an offer supplied from the offer transmission unit 31A through the interface 23.

The offer acceptance determination unit 33B determines, based on the information input by the negotiator B, whether or not to accept (i.e., agree on) the offer received by the offer receiving unit 32B. In this case, the processor 11 functions as the offer acceptance determination unit 33B by controlling the terminal device 2B. For example, under the control of the processor 11, the terminal device 2B displays the offer from the negotiator A based on the information received by the offer receiving unit 32B and receives a user input that specifies whether or not to agree on the offer and/or whether or not to suspend the negotiations. The terminal device 2B transmits the received input information to the platform providing device 1, and the processor 11 determines whether or not to accept (i.e., agree on) the offer based on the input information received from the terminal device 2B.

It is noted that the information which the offer receiving unit 32B has received includes the index value of the environmental loads. Therefore, if the offer from the negotiator A is displayed on the terminal device 2B, the offer acceptance determination unit 33B causes the terminal device 2B to display the index value of the environmental loads regarding the offer supplied from the negotiator A. In this way, the offer acceptance determination unit 33B notifies the second negotiator (i.e., negotiator B) of the offer supplied from the negotiator A with a clear indication of the index value of the environmental loads. Therefore, the offer acceptance determination unit 33B can enable the negotiator B to decide whether or not to agree on the offer and whether or not to suspend the negotiations taking into account the environmental loads.

Upon determining that the offer has come to an agreement, the offer acceptance determination unit 33B supplies the information indicating the agreed offer (i.e., information indicating the offer received by the offer receiving unit 32B) to the negotiation result display unit 34B. In addition, upon determining that there is no agreement on the entire offer and that there is an input specifying the suspension of the negotiations, the offer acceptance determination unit 33B determines that the negotiations should be suspended and supplies the information indicating the current offer to the negotiation result display unit 34B. The offer acceptance determination unit 33B may supply the information not only to the negotiation result display unit 34B but also to the negotiation result display unit 34A. Upon determining that there is no agreement on the offer and there is no input specifying the suspension of the negotiations, the offer acceptance determination unit 33B supplies the information indicating the offer and the determination result indicating that the offer is not acceptable to the offer generation/update unit 30B.

The offer generation/update unit 30B generates and updates the offer. In this case, the processor 11 functions as the offer generation/update unit 30B by controlling the terminal device 2B. For example, upon receiving the determination result indicating that the offer is not acceptable from the offer acceptance determination unit 33B, the offer generation/update unit generates a counteroffer based on input from the negotiator B. The terminal device 2B receives the input specifying the counteroffer and transmits the received input information to the platform providing device 1. The offer generation/update unit 30B may generate a new offer based on the input information received at any timing.

The offer transmission unit 31B supplies information indicating the offer generated or updated by the offer generating/update unit 30B to the offer receiving unit 32A. For example, the processor 11 functions as the offer transmission unit 31B.

The negotiation result display unit 34B displays on the terminal device 2B the negotiation result based on the information received from the offer acceptance determination unit 33B. In this instance, the processor 11 functions as the negotiation result display unit 34B to generate display information based on the information received from the offer acceptance determination unit 33B and supplies the generated display information to the terminal device 2B. For example, if the offer has come to an agreement, the negotiation result display unit 34B displays the information on the agreed offer on the terminal device 2B based on the information received from the offer acceptance determination unit 33B. On the other hand, if the offer does not come to an agreement, the negotiation result display unit 34B displays the information indicating the offer at the present time on the terminal device 2B. The negotiation result display unit 34B may display the negotiation result based on the information received from the offer acceptance determination unit 33A or the like on the terminal device 2B once the offer acceptance determination unit 33A makes the determination of the suspend of the negotiations.

The respective components of the offer generation/update unit 30A, the offer transmission unit 31A, the offer acceptance determination unit 33A, the negotiation result display 20) unit 34A, the environmental load calculation unit 35A, the offer generation/update unit 30B, the offer transmission unit 31B, the offer acceptance determination unit 33B, and the negotiation result display unit 34B described in FIG. 4 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (4) Environmental Load-Based Offer Generation and Acceptance Determination

Next, the details of environmental load-based offer generation and acceptance determination will be described. This section explains the method of reflecting the environmental loads in the utility and the method of using the environmental loads to filter the offer, respectively.

In the method of reflecting the environmental loads in the utility, the platform providing device 1 calculates the utility in consideration of the environmental loads. In this case, the platform providing device 1 decreases the utility with an increase in the degree of the environmental loads. In other words, the platform providing device 1 increases the utility with decreasing degree of environmental loads.

In this instance, for example, the utility function includes parameter(s) relating to the environmental loads, and the platform providing device 1 calculates the utility by the utility function based on the index value(s) of the environmental loads calculated by the environmental load calculation unit 35A. The parameter relating to the environmental loads is equivalent to index value of the environmental loads calculated by the environmental load calculation unit 35A. The utility function is a function to determine the utility so that the higher the degree of environmental loads indicated by the parameter relating to the environmental loads is, the smaller the utility becomes. In other words, the utility function is a function to determine the utility so that the utility increases with decreasing degree of environmental loads indicated by the parameter relating to the environmental loads. The utility function is previously stored in the memory 12 or the like.

In another example, the platform providing device 1 calculates the utility using the utility function having no parameter relating to the environmental load, and then corrects the utility based on the index value of the environmental loads calculated by the environmental load calculation unit 35A. In this case, for example, the platform providing device 1 calculates the utility by using a utility function having a price, delivery date, quantity, direct material cost, and the like as parameters as described in Patent Literature 1. Thereafter, the platform providing device 1 corrects the calculated utility so that the utility decreases with increasing degree of the environmental loads indicated by the index value calculated by the environmental load calculation unit 35A. In other words, the platform providing device 1 corrects the calculated utility so that the utility increases with decreasing degree of the environmental loads indicated by the index value calculated by the environmental load calculation unit 35A.

On the basis of the utility in which the environmental loads are considered in this manner, the platform providing device 1 makes a determination as to whether or not to accept an offer from the counterpart negotiator and a determination as to a new offer to the counterpart negotiator. For example, the offer acceptance determination unit 33A of the platform providing device 1 accepts the offer whose utility is equal to or larger than the predetermined threshold value, while it does not accept the offer whose utility is less than the above-described threshold value. In another example, the offer generation/update unit 30A of the platform providing device 1 generates a plurality of options and calculates utilities considering environmental loads for respective options. Then, the offer generation/update unit 30A selects the option having the highest utility as an offer to notify the other negotiator from the options.

In calculating the utility, the terms and conditions relating to the transport may be reflected in the utility. Examples of the terms and conditions relating to the transport include terms and conditions regarding the transportation means and the terms and conditions regarding transport distance. In this case, for example, the platform providing device 1 calculates the utility using a utility function including parameters relating to transport. Examples of parameters relating to transport include: a parameter (coefficient) that indicates the impact (e.g., delay penalties) on delivery time depending on the transportation means; a parameter that indicates the impact on the cost depending on the transportation means; and a parameter that indicates the impact on the environmental loads (such as amount of carbon dioxide emissions) depending on the transport distance.

Next, we explain how to use the environmental loads for filtering offers. In this instance, the platform providing device 1 filters the offers based on the comparison result between an index value of the environmental loads calculated by the environmental load calculation unit 35A and a predetermined threshold value.

For example, if the index value of the environmental load calculated by the environmental load calculation unit 35A for a certain offer option is worse (i.e., higher in terms of the environmental loads) than a predetermined threshold value, the platform providing device 1 determines that the certain offer option does not satisfy the requirement regarding the environmental loads. In such cases, for example, the offer generation/update unit 30A excludes the offer option for which the index value of the environmental load is worse than the threshold value from being selected as an offer to the negotiator B. In addition, upon receiving an offer for which the index value of the environmental loads is worse than the threshold value, the offer acceptance determination unit 33A does not accept the offer. On the other hand, if the index value of the environmental loads for a certain offer or offer option is equal to or better (i.e., lower in terms of the environmental loads) than the predetermined threshold value, the platform providing device 1 determines that the offer or offer option meets the requirement for the environmental loads, and leaves (i.e., does not exclude) the offer option as an option for the offer to the negotiator B or leaves the offer as an option for acceptance.

In some embodiments, the platform providing device 1 may not perform generation and acceptance determination of an offer based on the environmental loads. Even in this situation, the offer generation/update unit 30A includes the index value of the environmental loads calculated by the environmental load calculation unit 35A in the offer information to be sent by the offer transmission unit 31A to thereby notify the negotiator B of the index value of the environmental loads. Even in this case, negotiator B can determine whether or not to accept the offer from the negotiator A by referring to the displayed index value of the environmental loads.

### (5) Display Examples

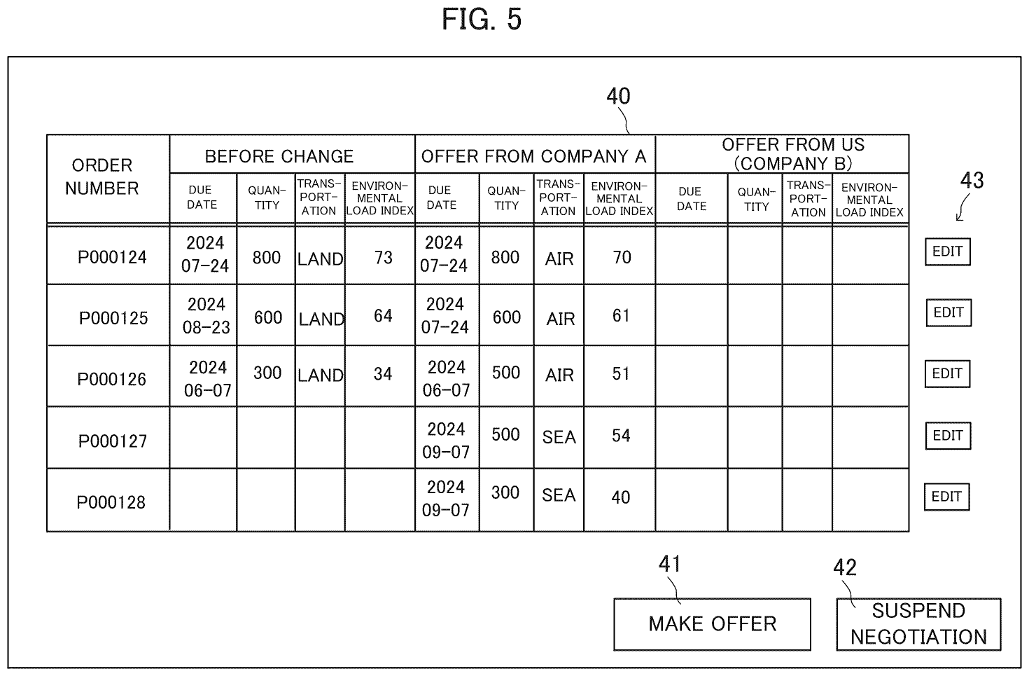

Next, specific examples of offer related information displayed by the terminal device 2B will be described with reference to FIGS. 5 to 8.

FIG. 5 is an example of an offer edit screen image before input by negotiator B. Here, once the negotiator B (here referred to as “Company B”) inputs information to the effect that the offer generated or updated by the negotiator A (here referred to as “Company A”) is not acceptable, the offer edit screen image for generating a counteroffer is displayed. The platform providing device 1 generates the display information based on the offer generated or updated by the negotiator A and transmits the display information to the terminal device 2B, thereby causing the terminal device 2B to display the offer edit screen image shown in FIG. 5 based on the display information.

The platform providing device 1 provides, on the offer edit screen image shown in FIG. 5, an offer management table 40 having records for respective order numbers, an offer determination button 41 indicating “MAKE OFFER”, a negotiation suspend button 42 indicating “SUSPEND NEGOTIATION”, and edit buttons 43 provided for respective order numbers.

The offer management table 40 has records of orders for respective order numbers, and has items “ORDER NUMBER”, “BEFORE CHANGE”, “OFFER FROM COMPANY A”, and “OFFER FROM US (COMPANY B)”. The item “ODER NUMBER” indicates the order number corresponding to each record. In addition to the order number, the identification information of the products corresponding to the order number (including product names and the like) may be further displayed therein.

The item “BEFORE CHANGE” indicates the terms and conditions of the corresponding order number before the negotiator A proposes the offer. The item “OFFER FROM COMPANY A” indicates the offers from negotiator A for respective order numbers. The item “OFFER FROM US (COMPANY B)” indicates counteroffers for the offers described in the item “OFFER FROM COMPANY A” for respective order numbers. FIG. 5 shows the initial state before input by the negotiator B and therefore no input has yet been made to the item “OFFER FROM US (COMPANY B)”. The item “BEFORE CHANGE” in the record of a new order is blank.

Here, each item “BEFORE CHANGE”, “OFFER FROM COMPANY A”, and “OFFER FROM US (COMPANY B)” sub-items “DUE DATE”, “QUANTITY”, “TRANSPORTATION”, and “ENVIRONMENTAL LOAD INDEX” which indicate detailed values for respective terms and conditions. The sub-item “DUE DATE” indicates the due date (year-month-day) of the products for each order number. The sub-item “QUANTITY” indicates the quantity of products per order number. The sub-item “TRANSPORTATION” indicates the transportation means of the products for each order number. The sub-item “ENVIRONMENTAL LOAD INDEX” indicates an index value that indicates the degree of environmental loads required for procurement (including production and transportation) of the products per order number. The illustrated sub-items are just examples, sub-items indicating any other terms and conditions such as price may be provided.

The offer determination button 41 is a button for deciding to notify the counterpart (the negotiator A in this case) of the proposal displayed in the item “OFFER FROM US (COMPANY B)” in the offer management table 40 as a counteroffer. The negotiation suspend button 42 is a button for deciding to suspend the negotiations. The edit buttons 43 are graphical user interfaces (GUI: Graphical User Interfaces) for editing (inputting) counteroffers for respective order numbers. These buttons are not limited to being displayed as illustrated, and may be realized in any other mode.

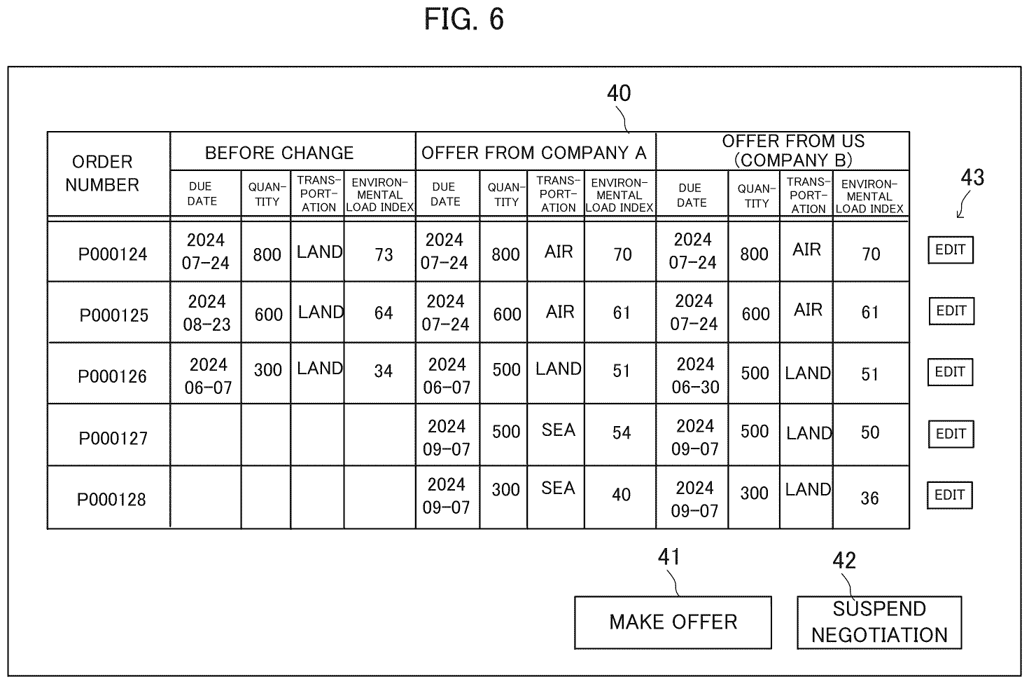

FIG. 6 is an example of an offer edit screen image after the input by the negotiator B. FIG. 6 illustrates the offer edit screen image after the input regarding counteroffers for respective order numbers has been made. In the example shown in FIG. 6, the counteroffer entered after the selection of the edit button 43 is displayed in the item “OFFER FROM US (COMPANY B)”. For example, in the records corresponding to the order numbers “P000124” and “P000125”, the content of the offer from the negotiator A displayed on the item “OFFER FROM COMPANY A” is matched with the content of the offer from the negotiator B displayed on the item “OFFER FROM US (COMPANY B)”. On the other hand, in the record of the order number “P000126”, the contents are different in the sub-item “DUE DATE” while the contents match in the other sub-items.

It is noted that the value input by the negotiator B may be displayed in the sub-item “ENVIRONMENTAL LOAD INDEX” or the index value of the environmental loads calculated by the platform providing device 1. In the latter example, on the basis of the contents input to other sub-items in the item “OFFER FROM US (COMPANY B)”, the platform providing device 1 calculates the index value of the environmental loads of the counteroffer for each order number input by the negotiator B, and displays the calculated index value in the sub-item “ENVIRONMENTAL LOAD INDEX”.

Once the negotiations are suspended (suspended) or once the offer has come to an agreement, the platform providing device 1 may display the negotiation result including the index value of the environmental loads as shown in FIG. 6 on the terminal device 2A. Thus, the platform providing device 1 can suitably allow the negotiator A to grasp the negotiation result including information relating to the environmental loads.

### (6) Processing Flow

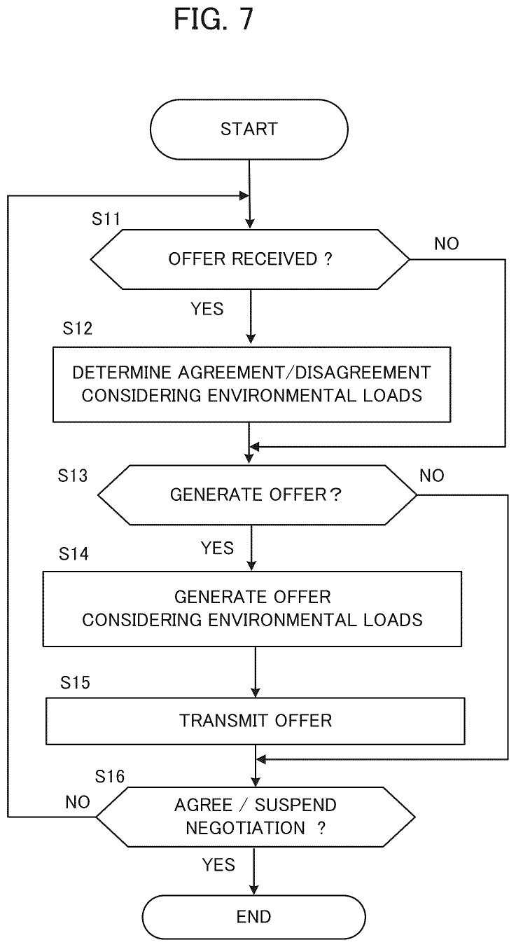

FIG. 7 is an example of a flowchart executed by the platform providing device 1 through the negotiation AI. The process of the flowchart shown in FIG. 7 mainly corresponds to the process executed by the offer generation/update unit 30A, the offer acceptance determination unit 33A, and the environmental load calculation unit 35A of the platform providing device 1.

First, the platform providing device 1 determines whether or not the negotiator (the negotiator A in this case) represented by the negotiation AI has received an offer from the other negotiator (the negotiator B in this case) (step S11).

Then, upon determining that the offer has been received (step S11; Yes), the platform providing device 1 determines whether or not the offer is acceptable in consideration of the environmental loads (step S12). In this case, the platform providing device 1 refers to the environmental load information stored in the environmental load information storage unit 123 and the component information stored in the component information storage unit 124, and calculates an index value of the environmental loads of the received offer. Then, the platform providing device 1 determines whether or not the offer is acceptable considering the calculated index value of the environmental loads. On the other hand, upon determining that the offer has not been received (step S11; No), the platform providing device 1 proceeds with the process at step S13.

Next, the platform providing device 1 determines whether or not to generate an offer (step S13). For example, upon determining at step S12 that the offer is not acceptable, the platform providing device 1 determines that an offer (i.e., counteroffer) should be generated. In contrast, upon determining at step S12 that the offer is acceptable, the platform providing device 1 determines that an offer (i.e., counteroffer) should not be generated. In addition, if a predetermined condition for generating an offer is satisfied (e.g., if an input instructing generation of an offer is detected or the like), the platform providing device 1 decides to generate an offer even when the offer has not been received.

Upon determining that the offer should be generated (step S13; Yes), the platform providing device 1 generates an offer considering the environmental loads (step S14). In this case, for example, the platform providing device 1 determines an offer to the negotiator B using the index value of the environmental loads identified by referring to the environmental load information stored in the environmental load information storage unit 123 and the component information stored in the component information storage unit 124. Then, the platform providing device 1 transmits the generated offer to the other negotiator (step S15). Thus, the platform providing device 1 causes the terminal device 2B to display the offer including information regarding the environmental loads. On the other hand, upon determining that the offer should not be generated (step S13; No), the platform providing device 1 proceeds with the process at step S16.

Next, the platform providing device 1 determines whether or not the offer comes to an agreement or the negotiations should be suspended (step S16). The platform providing device 1 terminates the process of the flowchart upon determining that the offer has come to an agreement or that the negotiations should be suspended (step S16; Yes). On the other hand, upon determining that the offer does not come to an agreement and that the negotiations should not be suspended (step S16; No), the platform providing device 1 proceeds back to the process at step S11.

### (4) Modifications

Next, a description will be given of modifications applicable to the embodiment described above. The following modifications may be applied in any combination.

### (First Modification)

The negotiation AI may be executed by the terminal device 2A, instead of being executed by the platform providing device 1.

In this case, the terminal device 2A stores the model information stored by the model information storage unit 122 in the memory 22, and the processor 21 of the terminal device 2A executes the negotiation AI by referring to the model information. Then, in the same way as the above-described example embodiment, the negotiation AI calculates an index value of the environmental load and performs generation and acceptance determination of an offer considering the environmental loads. Also in this modification, it is possible to suitably realize the automatic negotiations of the negotiator A.

### (Second Modification)

The functions of the platform providing device 1 may be incorporated in the terminal device 2.

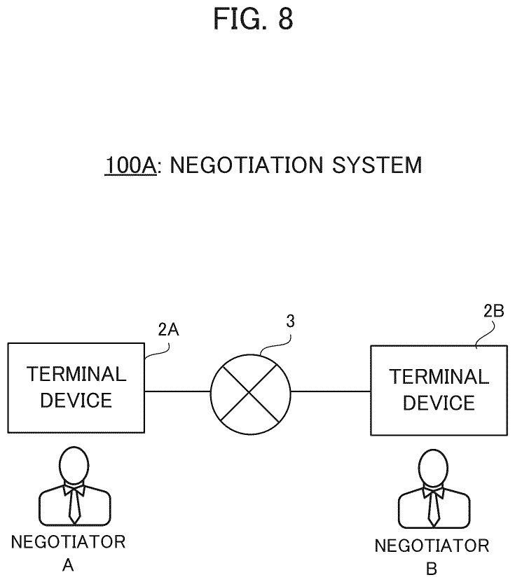

FIG. 8 shows a configuration of a negotiation system 100A. The negotiation system 100A includes a terminal device 2A used by the negotiator A and a terminal device 2B used by the negotiator B. The terminal device 2A and the terminal device 2B performs data communication with each other via the network 3. Then, at least one of the terminal device 2A and/or the terminal device 2B executes the process performed by the platform providing device 1 in FIG. 1 to realize a negotiation platform.

As shown in FIG. 8, even in a mode in which the terminal devices 2 used for negotiations performs data communication with each other, the terminal devices 2 can exchange information necessary for the negotiations to suitably execute the processes related to the notification and acceptance of the offer.

### Second Example Embodiment

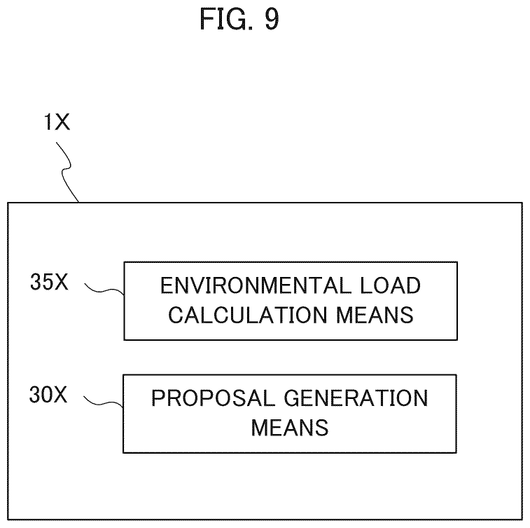

FIG. 9 is a functional block diagram of the negotiation device 1X. The negotiation device 1X mainly includes an environmental load calculation means 35X and a proposal generation means 30X. The negotiation device 1X may be configured by a plurality of devices. Examples of the negotiation device 1X include the platform providing device 1 in FIG. 1 and the terminal device 2A or terminal device 2B in FIG. 8.

The environmental load calculation means 35X is configured to calculate environmental loads regarding an order subject to a negotiation conducted by a first negotiator with a second negotiator. Examples of the environmental load calculation means 35X include the environmental load calculation unit 35A in the first example embodiment.

The proposal generation means 30X is configured to generate a proposal regarding the order based on the environmental loads. Examples of the proposal generation means 30X include the offer generation/update unit 30A in the first example embodiment.

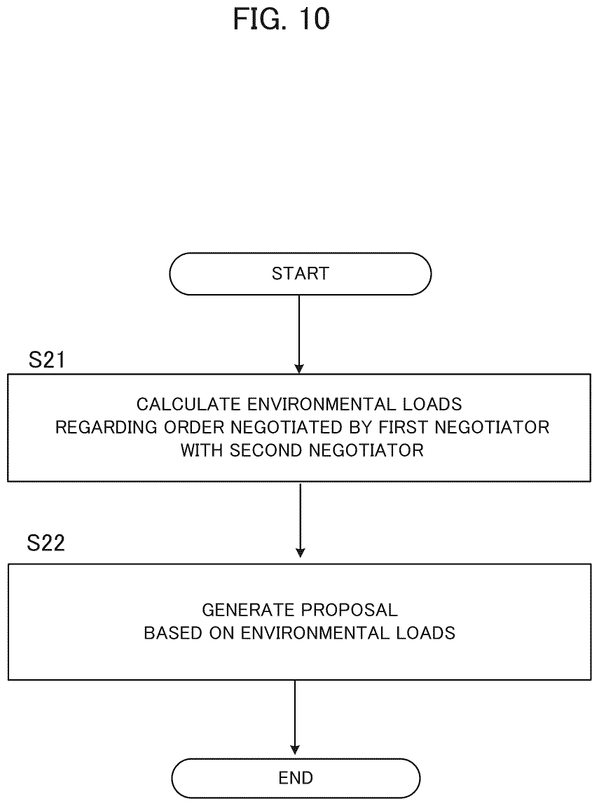

FIG. 10 is an example of a flowchart executed by the negotiation device 1X. The environmental load calculation means 35X calculates environmental loads regarding an order subject to a negotiation conducted by a first negotiator with a second negotiator (step S21). The proposal generation means 30X generates a proposal regarding the order based on the environmental loads (step S22).

The negotiation device 1X according to the second example embodiment can generate a proposal in which the environmental load is suitably considered in the negotiation.

In addition, some or all of the above-described example embodiments (including modifications, the same shall apply hereinafter) may also be described as follows, but are not limited to the following. In addition, some or all of the configurations described in Supplementary Notes 2 to 8 which are dependent on Supplementary Note 1 may be dependent on Supplementary Notes 9 and 10 by the same dependence as Supplementary Notes 2 to 8. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

A negotiation device comprising:
an environmental load calculation means configured to calculate environmental loads regarding an order subject to a negotiation conducted by a first negotiator with a second negotiator; and
a proposal generation means configured to generate a proposal regarding the order based on the environmental loads.

### [Supplementary Note 2]

The negotiation device according to Supplementary Note 1,
wherein the environmental load calculation means is configured to
   identify, based on component information regarding components and environmental load information regarding the environmental loads of the components, environmental loads for respective components constituting products subject to the order, and
   calculate the environmental loads regarding the order based on a sum of the environmental loads for the respective components.

### [Supplementary Note 3]

The negotiation device according to Supplementary Note 1, further comprising
a proposal notification means configured to notify the second negotiator of the proposal with an indication of an index value indicating the environmental loads.

### [Supplementary Note 4]

The negotiation device according to Supplementary Note 1,
wherein the proposal includes terms and conditions specifying a transportation means, and
wherein the environmental load calculation means is configured to calculate the environmental loads in accordance with the transportation means.

### [Supplementary Note 5]

The negotiation device according to Supplementary Note 1, further comprising
a determination means configured to, upon receiving an alternative proposal other than the proposal from the second negotiator, determine whether or not to agree on the alternative proposal based on environmental loads regarding the alternative proposal.

### [Supplementary Note 6]

The negotiation device according to Supplementary Note 5,
wherein the environmental load calculation means is configured to calculate the environmental loads regarding the alternative proposal and
wherein the determination means is configured to determine whether or not to agree on the alternative proposal based on the calculated environmental loads regarding the alternative proposal.

### [Supplementary Note 7]

The negotiation device according to Supplementary Note 1,
wherein the proposal generation means is configured to
   calculate utilities of respective proposals regarding the order based on environmental loads of the respective proposals, and
   select, based on the utilities, the proposal for notifying the second negotiator from the respective proposals.

### [Supplementary Note 8]

The negotiation device according to Supplementary Note 1,
wherein the proposal generation means is configured to, if a degree of the environmental loads of the proposal is higher than a threshold value, exclude the proposal from a target of notification to the second negotiator.

### [Supplementary Note 9]

A negotiation method executed by a computer, comprising:
calculate environmental loads regarding an order subject to a negotiation conducted by a first negotiator with a second negotiator; and
generate a proposal regarding the order based on the environmental loads.

### [Supplementary Note 10]

A program executed by a computer, the program causing the computer to:
calculate environmental loads regarding an order subject to a negotiation conducted by a first negotiator with a second negotiator; and
generate a proposal regarding the order based on the environmental loads.

### [Supplementary Note 11]

A storage medium storing a program according to Supplementary Note 10.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Platform providing device
2 (2A, 2B) Terminal device
3 Network
4 Storage device
100, 100A Negotiation system

What is claimed is:

1. A negotiation device comprising:
at least one memory configured to store instructions; and
at least one processor configured to execute the instructions to:
calculate environmental loads regarding an order subject to a negotiation conducted by a first negotiator with a second negotiator; and
generate a proposal regarding the order based on the environmental loads.

2. The negotiation device according to claim 1,
wherein the at least one processor is configured to execute the instructions to
identify, based on component information regarding components and environmental load information regarding the environmental loads of the components, environmental loads for respective components constituting products subject to the order, and
calculate the environmental loads regarding the order based on a sum of the environmental loads for the respective components.

3. The negotiation device according to claim 1,
wherein the at least one processor is configured to further execute the instructions to
notify the second negotiator of the proposal with an indication of an index value indicating the environmental loads.

4. The negotiation device according to claim 1,
wherein the proposal includes terms and conditions specifying a transportation means, and
wherein the at least one processor is configured to execute the instructions to calculate the environmental loads in accordance with the transportation means.

5. The negotiation device according to claim 1,
wherein the at least one processor is configured to execute the instructions to, upon receiving an alternative proposal other than the proposal from the second negotiator, determine whether or not to agree on the alternative proposal based on environmental loads regarding the alternative proposal.

6. The negotiation device according to claim 5,
wherein the at least one processor is configured to execute the instructions to
calculate the environmental loads regarding the alternative proposal and
determine whether or not to agree on the alternative proposal based on the calculated environmental loads regarding the alternative proposal.

7. The negotiation device according to claim 1,
wherein the at least one processor is configured to execute the instructions to
calculate utilities of respective proposals regarding the order based on environmental loads of the respective proposals, and
select, based on the utilities, the proposal for notifying the second negotiator from the respective proposals.

8. The negotiation device according to claim 1,
wherein the at least one processor is configured to execute the instructions to, if a degree of the environmental loads of the proposal is higher than a threshold value, exclude the proposal from a target of notification to the second negotiator.

9. A negotiation method executed by a computer, comprising:
calculate environmental loads regarding an order subject to a negotiation conducted by a first negotiator with a second negotiator; and
generate a proposal regarding the order based on the environmental loads.

10. A non-transitory computer readable storage medium storing a program executed by a computer, the program causing the computer to:
calculate environmental loads regarding an order subject to a negotiation conducted by a first negotiator with a second negotiator; and
generate a proposal regarding the order based on the environmental loads.
